(19) United States
(12) Patent Application Publication
(10) Pub. No.: US 2026/0060166 A1
(43) Pub. Date: Mar. 5, 2026

(54) A Row Unit

(71) Applicant: Precision Planting LLC, Tremont, IL (US)

(72) Inventors: Jeremy J. Hodel, Morton, IL (US); Justin McMenamy, Edwards, IL (US)

(21) Appl. No.: 19/105,991

(22) PCT Filed: Oct. 16, 2023
(86) PCT No.: PCT/IB2023/060415

§ 371 Date: Feb. 24, 2025

Related U.S. Application Data
(60) Provisional application No. 63/383,765, filed on Nov. 15, 2022.

(51) Int. Cl. A01C 7/04; A01C 5/06; A01C 7/20

(52) U.S. Cl. CPC A01C 7/046; A01C 7/206; A01C 5/064; A01C 5/068

(57) ABSTRACT

A seed delivery system comprising a seed meter (128, 129) supported by an agricultural row unit frame (110) and comprising a metering disc (120, 129) configured to hold a plurality of seeds; a seed inductor (402) such as an accelerator configured to flow a pressurized airstream therethrough to dislodge seeds from the metering disc (120, 129) which are discharged to a seed dispensing tube (130). The dispensing tube (130) receives the airstream with entrained seeds from the seed accelerator (300, 350) and dispenses the seeds from a discharge opening (130) at bottom into a planting trench (104). The suction side of a fan (210) is fluidly coupled to one side of the seed meter (128, 129) for providing a vacuum thereto and discharge side is fluidly coupled to the accelerator for providing pressurized air to the accelerator. A pressure regulator (215) may be provided to control the air pressure of air discharged by the fan (210) to the accelerator.

### CROSS REFERENCE TO RELATED APPLICATIONS

The present application claims the benefit of priority to U.S. Application No. 63/383,765, filed 15 Nov. 2022, which is incorporated herein by reference in its entirety.

### FIELD

Embodiments of the present disclosure relate generally to seed delivery systems used in conjunction with planting crops, and more particularly to a fan system configured to provide a source of vacuum and pressure for operation of a crop planting row unit.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Spacing of seeds can affect yield because plants that are too close together compete for nutrients, and plants too far apart leave wasted space between them.

Agricultural row unit crop planters typically include a seed hopper connected to a seed metering system that delivers seeds into a furrow formed by disc opener blades. A plurality of these row crop planters are typically mounted in parallel along a tool bar which is attached to a powered vehicle such as a tractor which traverses the agricultural field. For example, it is common to have four, sixteen, twenty-four, thirty-six, or even forty-eight row units attached to a single tractor.

Within a typical prior art row unit crop planter, seeds are delivered in bulk from the seed hopper to the metering system. The metering system singulates the bulk seeds and will most preferably provide these singulated seeds at very predictable and repeatable time intervals. The row unit crop planter subsequently delivers one seed at a time into the ground, typically into a furrow cut by the opener blades.

Row unit crop planters with vacuum seed meters typically use a vacuum system to provide vacuum to the seed meter to adhere seeds to a seed disc. Also, there are seed delivery systems that use air pressure to deliver seed to the furrow from the seed meter or to provide air pressure to orient seeds from the seed meter to the furrow. Examples of pressure delivery systems include the following publications: U.S. Pat. Nos. 8,336,471B2, 9,137,941B2, EP2702849B1, DE202012013691U1, DE102012108006A1, EP2974582B1, DE102014110035A1, WO2021023409A1, DE102019121150A1, DE102019121155A1, U.S. Pat. Nos. 9,043,950B2, 9,521,804B2, 10,448,561B2, 10,993,366B2, 10,999,966B2, US20190239425A1, U.S. Pat. Nos. 10,820,489B2, 10,743,460B2, US20200359552A1, U.S. Pat. Nos. 9,756,779B2, 10,945,363B2, 10,959,368B2, US20200359551A1, US20210153423A1, US20210051844A1, US20210315152A1, WO2021069599A1, and WO2021069607A1. Examples of orientation systems include PCT Publication Nos. WO2018013858A1, WO2018013859A1, WO2018013860A2, and WO2018013861A1. One particular type of seed orienter is described in U.S. Patent Publication No. US2020/0367425A1 and US2022/0192079A1.

The pressure in some row units is provided by a separate system than the vacuum system. It would be advantageous to reduce complexity and the number of components for the planting system.

### BRIEF SUMMARY

The present disclosure in one aspect provides a fan system for an agricultural row unit crop planter which is configured to provide both vacuum for retaining seeds on the seed meter and pressurized air for ejecting seeds from the seed meter for planting. The pressurized air may be provided to a seed inductor which removes the seeds from the meter via the pressurized airflow and discharges the dislodged seeds into a seed dispensing tube. In one embodiment, the seed inductor may be a seed accelerator as further described herein, or other type seed inductors usable with a seed meter. The seeds are expelled from the bottom end of the tube and implanted into an awaiting planting furrow or trench formed by the row unit as it traverses the agricultural field. The system may further be configured to control the pressure of the air supplied to the seed accelerator so that an optimum amount of air sufficient to convey and properly orient the seeds for planting in the trench is achieved.

In some embodiments, an agricultural row unit comprises: a frame; a seed meter disposed on the frame; an inductor coupled to the seed meter; a seed tube coupled to the inductor; a fan fluidly coupled to the seed meter for providing a vacuum to the seed meter and fluidly coupled to the inductor for providing pressurized air to the inductor; and a pressure regulator fluidly interposed between the fan and inductor which is configured to control a pressure of the air to the inductor. The air pressure may be adjustable in some embodiments. In one embodiment, the air pressure may be automatically controlled by a programmable controller.

Various embodiments of an air-operated seed accelerator described herein are configured to capture and dispense seeds from the seed meter by entraining the seeds in the pressurized airstream and increasing the velocity of the seeds to a desired value via the air pressure regulator.

A first air-operated seed accelerator is configured to convey the airstream through an air entrainment chamber of a seed capture shroud from an inward to an outward and downward direction across the metering disc to capture the seeds from the seed holes.

A second air-operated seed accelerator is configured to convey the airstream through the air entrainment chamber of the seed capture shroud from an outward to an inward and downward direction across the metering disc to capture the seeds from the seed holes.

The metering disc of the seed meter may be configured to singulate seed received from a seed hopper and provide the seeds to the seed dispensing tube in a preselected orientation.

The seed dispensing tube may have a generally cylindrical interior, and in some embodiments at least a portion of the tube may comprise helical seed orientation surfaces which engage and manipulate the seeds to provide a predetermined seed orientation for planting in the planting trench.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example (“exemplary”) embodiments when read in conjunction with the accompanying drawings, in which the features of the exemplary embodiments will be described with reference to the following drawings where like elements are labeled similarly, and in which:

FIG. 1 is a perspective view of a crop planter row unit including a seed delivery system according to the present disclosure;

FIG. 2 is an enlarged detail view thereof with one of the guide wheels removed;

FIG. 3 is a side view of the row unit;

FIG. 4 is a top perspective view of a portion of the row unit with a seed delivery system according to the present disclosure;

FIG. 5 is a bottom perspective view thereof;

FIG. 6 is a rear view thereof;

FIG. 7 is a front view thereof;

FIG. 8 is a left side view thereof relative to the direction of travel of the row unit;

FIG. 9 is a right side view thereof;

FIG. 10 is a top view thereof;

FIG. 11 is a bottom view thereof;

FIG. 12 is a rear perspective view thereof with seed hopper removed;

FIG. 13 is a front perspective view thereof with seed hopper removed;

FIG. 14 is a first exploded perspective view thereof;

FIG. 15 is a second exploded perspective view thereof;

FIG. 16 is a perspective view of a portion of the row unit with a first embodiment of an air-operated seed accelerator according to the present disclosure;

FIG. 17 is an enlarged detail of the seed accelerator in FIG. 16;

FIG. 18 is an enlarged detail view showing a seed capture shroud of the seed accelerator in FIG. 17 and a portion of the seed metering disc of the seed meter showing seed holes of the disc entering the shroud;

FIG. 19 is a first perspective view of the air-operated seed accelerator of FIG. 16;

FIG. 20 is a second perspective view thereof;

FIG. 21 is a third perspective view thereof;

FIG. 22 is a side view of the seed meter with seed metering disc and seed dispensing tube with the first embodiment of the seed accelerator shown in phantom dashed lines;

FIG. 23 is side cross sectional view of a portion of the metering disc showing the first embodiment of the seed accelerator in FIG. 22;

FIG. 24 is a perspective view of a portion of the row unit with a second embodiment of an air-operated seed accelerator according to the present disclosure;

FIG. 25 is an exploded perspective view thereof;

FIG. 26 is an enlarged detail taken from FIG. 25 showing the sub-trench opener which is common to all embodiments of the row unit disclosed herein;

FIG. 27 is an enlarged detail view showing a seed capture shroud of the second embodiment of the seed accelerator in FIG. 24 and a portion of the seed metering disc of the seed meter showing seed holes of the disc entering the shroud;

FIG. 28 is a first perspective view of the air-operated seed accelerator of FIG. 16;

FIG. 29 is a second perspective view thereof;

FIG. 30 is a third perspective view thereof;

FIG. 31 is a side view of the seed meter with seed metering disc and seed dispensing tube with the second embodiment of the seed accelerator shown in phantom dashed lines;

FIG. 32 is side cross sectional view of a portion of the metering disc showing the second embodiment of the seed accelerator in FIG. 31;

FIG. 33 is a right side view of a row unit with a fan system according to the present disclosure;

FIG. 34 is a right view thereof showing a seed dispensing tube coupled with a seed orienter at the lower discharge portion of the tube;

FIG. 35 is a partial left side view of the row unit assembled perspective view thereof;

FIG. 36 is a schematic diagram showing a first embodiment of an air pressure regulator usable with the fan system; and

FIG. 37 is a schematic diagram showing a second embodiment of an air pressure regulator usable with the fan system.

All drawings are schematic and not necessarily to scale. Parts shown and/or given a reference numerical designation in one figure may be considered to be the same parts where they appear in other figures without a numerical designation for brevity unless specifically labeled with a different part number and described herein. A reference herein to a figure by number but which includes multiple figures sharing the same number with different alphabetical suffixes shall be considered as a reference to all of those figures unless noted otherwise.

### DETAILED DESCRIPTION

All references to other patent applications (e.g., patents or published patent applications) cited herein are incorporated herein by reference in their entireties. If there is a conflict between a definition herein and in an incorporated reference, the definition herein shall control.

The illustrations presented herein are not actual views of any planter row unit or portion thereof, but are merely idealized representations to describe example embodiments of the present disclosure. Additionally, elements common between figures may retain the same numerical designation.

The following description provides specific details of embodiments (i.e. examples). However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of”and “consisting essentially of”and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, orientation, arrangement, and other physical attributes of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used herein, the term “about” used in reference to a given parameter is inclusive of the stated value and has the meaning dictated by the context (e.g., it includes the degree of error associated with measurement of the given parameter or manufacturing tolerances).

As used throughout, ranges are used as shorthand for describing each and every value that is within the range. Any value within the range can be selected as the terminus of the range.

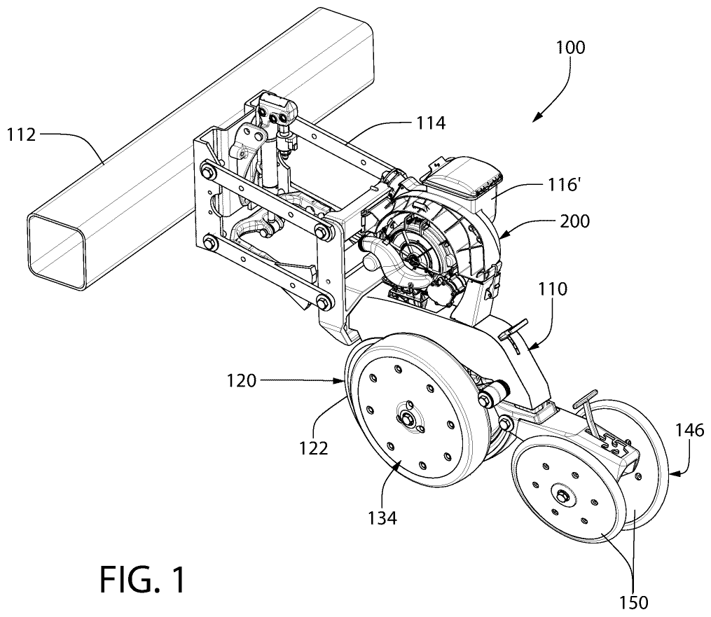

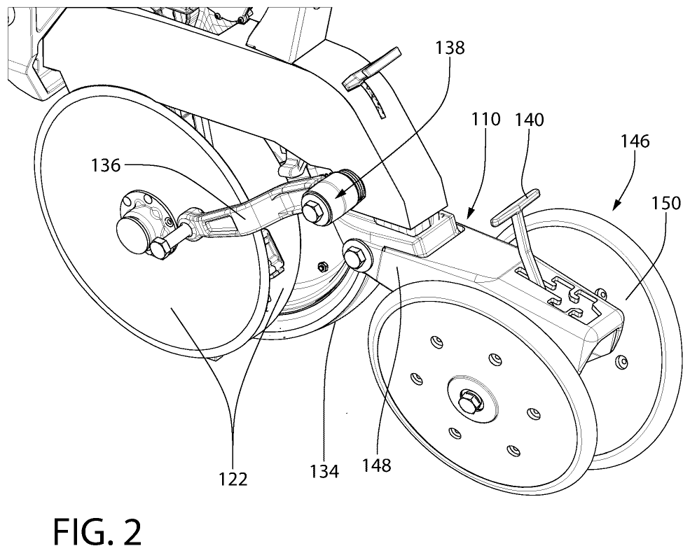

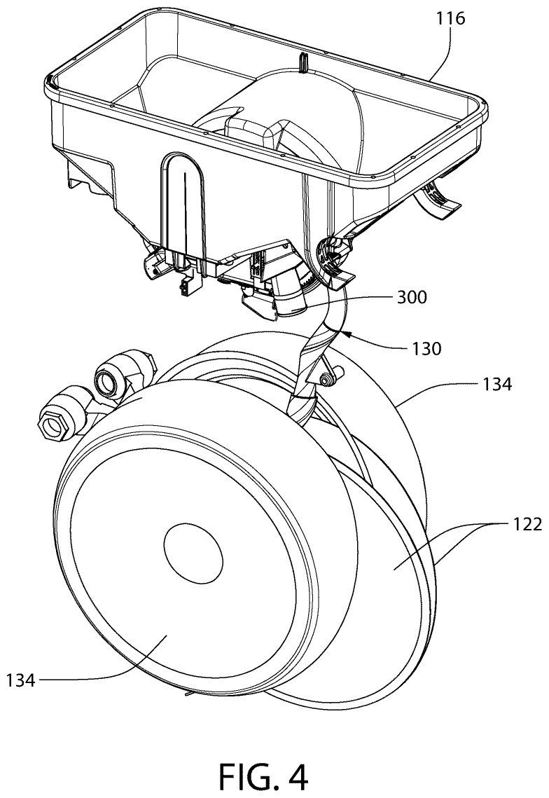

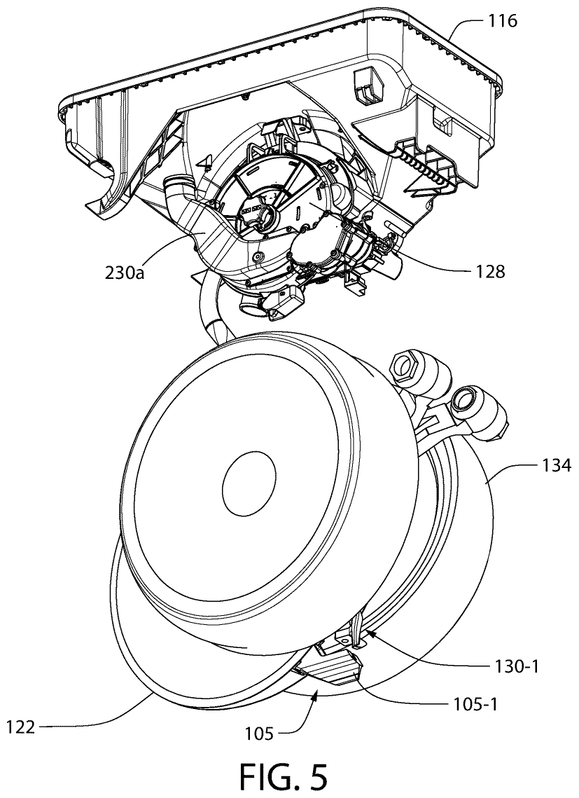

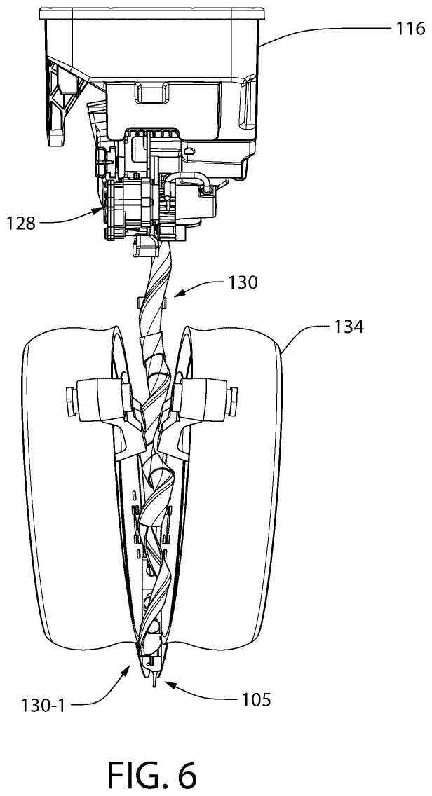

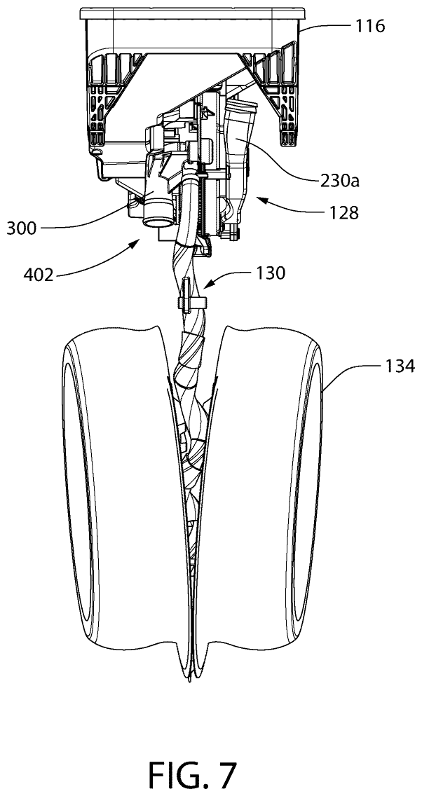

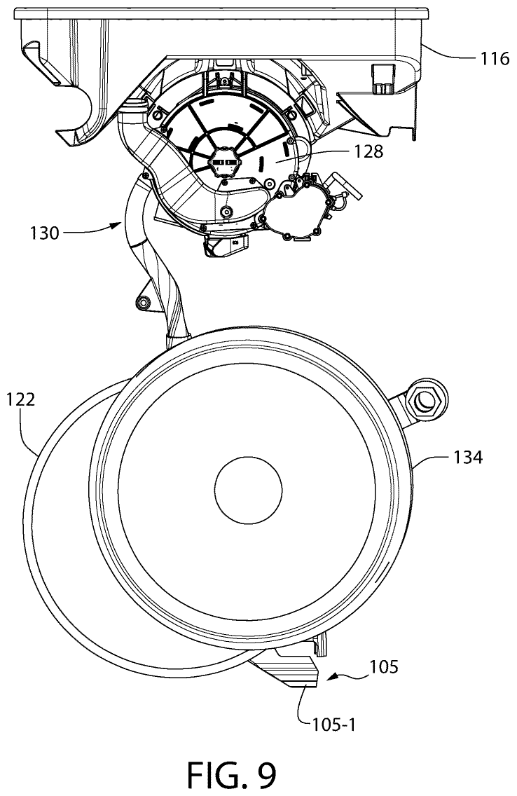

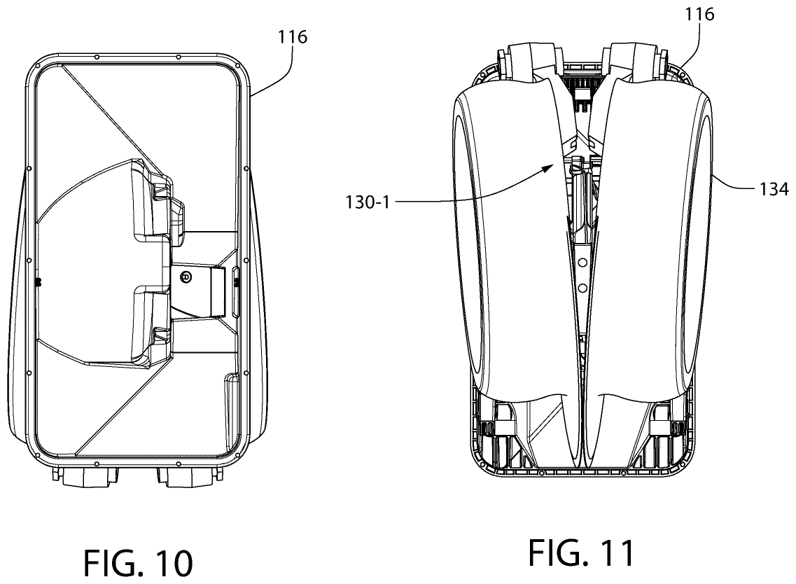

FIGS. 1-3 illustrate an embodiment of an agricultural planter row unit 100. The row unit 100 has a support frame 110 pivotally connected to a toolbar 112 by a movable parallel linkage arm assembly 114 comprising pairs of parallel arms 114a coupled between frame 110 and toolbar 112 enabling each row unit 100 to move vertically independently of the toolbar 112 and of other row units 100 as the row unit traverses the agricultural field. The frame 110 operably supports one or more seed hoppers 116 of any suitable type and configuration which hold seeds for planting, a seed trench opening assembly 120, a seed delivery system 200 which draws seeds from the hopper and dispenses the seed to the planting trough, and a seed trench closing assembly 146. The row unit 100 shown may also be used with a conventional planter row unit each having a single individual large capacity seed hopper 116 which is individually filled with seeds (see, e.g., FIGS. 4-11).

Alternatively, the row unit of FIGS. 1-3 may be used with a central fill planter, in which latter case the large capacity hoppers 116 previously described herein may be replaced with one or more mini-hoppers 116′ mounted to each row unit as shown. The mini-hoppers are fluidly coupled to a large central hopper via fill tubes (not shown) which in turn distributes the seeds to all row units. Such central fill planters are well known in the art without further elaboration necessary.

It bears noting that the support frame 110 is used to collectively designate an assemblage of various structural members (e.g., beams, angles, straps, braces, rods, brackets, and other components) which are coupled together and cooperate to structurally support some or all of the components and devices of the row unit 100 and seed delivery system 200 described herein. Any suitable types and number of structural members may be provides in any suitable configuration for this purpose.

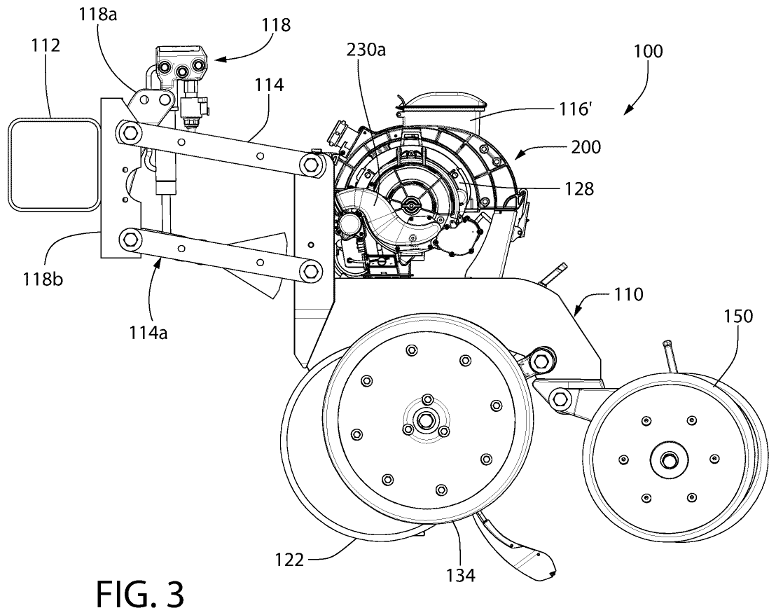

A downforce control system as disclosed in comprises a downforce controller 118 for transmitting a net downforce between the agricultural toolbar and the agricultural row unit to keep the row unit positively engaged with the soil. The controller 118 may comprise double acting hydraulic cylinder acting on one or more arms 114a which applies the force to the linkage arm assembly. The downforce controller assembly includes bracket 118a which may be fixedly coupled to linkage arm mounting bracket 118b that coupled linkage arm assembly 114 to toolbar 112 in one embodiment. The downforce control system 118 shown in FIG. 3 is therefore disposed and operable to apply lift and/or downforce on the row unit 100, such as disclosed in U.S. Pat. No. 10,443,631.

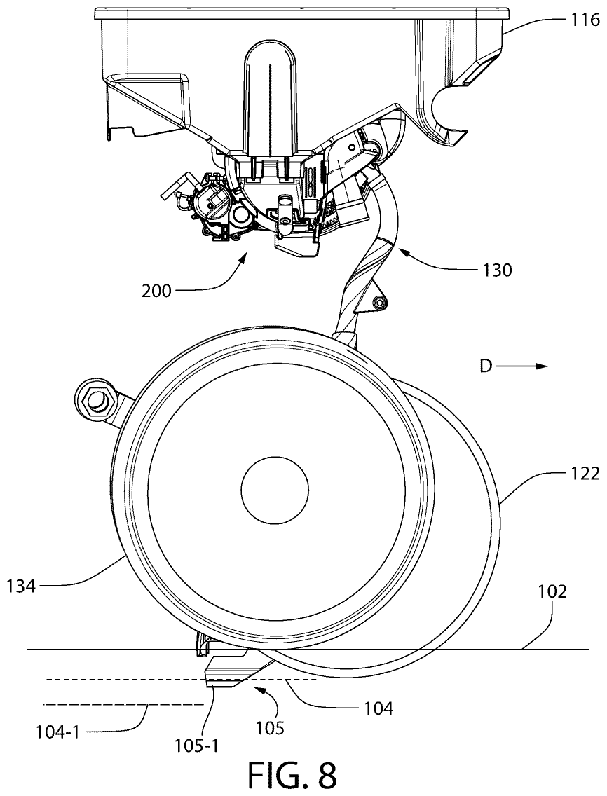

Referring to FIGS. 1-11 in general as applicable, the seed trench opening assembly 120 includes a pair of opening discs 122 rotatably supported by the frame 110. The opening discs 122 are arranged to diverge outwardly and rearwardly so as to open a V-shaped seed furrow or trench 104 in the soil 102 (see, e.g., FIG. 8) as the planter traverses the field in a forward direction of travel D. In other embodiments, a seed-trench opening assembly is described in U.S. Ser. No. 63/262,415, filed 12 Oct. 2021, and U.S. Ser. No. 63/262,417, filed 12 Oct. 2021 may be used. In some embodiments, notched discs can be used as opening discs 122. Examples of notched discs are disclosed in U.S. Application No. 63/385,568, filed 30 Nov. 2022. FIGS. 8-11 from 63/385,568, reproduced here as FIGS. 42-45, illustrate the notched opener disc 62. Notched opener disc 62 has a plurality of notches 63 (63-1 to 63-18). While illustrated with 18 notches, notches opener disc 62 can have any number of notches 63. Between successive notches 63 is a tooth 64. As illustrated, there are 18 teeth 64 (64-1 to 64-18). Optionally, tooth 64 can have a taper 65 (65-1 to 65-18). While illustrated with taper 65 on one side of tooth 64, both sides of tooth 64 can have a taper 65. When there is one taper 65, notched opener disc 62 can be oriented on row unit 14 such that taper 65 is disposed on notched opener disc 62 on a side away from row unit 14. While illustrated as flat, notched opener disc 62 can be concave. FIG. 41 illustrates notched opener discs 62 in the embodiment from FIG. 8.

In some embodiments, a sub-trench opener 105 can optionally be included. Sub-trench opener 105 is coupled to row unit 100 such as to an available portion of frame 110 by mounting bracket 105-3 (see, e.g., FIGS. 25-26 and 55). Sub-trench opener 105 is disposed rearward from opening disc assembly 60 in the trench opened by seed trench opening assembly 120. The sub-trench opener 105 can optionally comprise a blade 105-1 which extends below opening discs 112 to create an optional sub-trench 104-1 in the soil at the bottom of and within planting trench 104. This creates a more smaller V-shaped compact trench profile within the larger outer trench 104 so that seeds deposited into the sub-trench are constrained from moving laterally or forwardly/rearwardly in the soil to maintain their preferred orientation and position in the trench. Seed dispensing tube 130 can be arranged and positioned to deposit seeds into the sub-trench via the tube discharge opening 130-1 at bottom behind and following the sub-trench opener 105 relative to the direction of travel D of the row unit 100 through the agricultural field.

Mounting Bracket 105-3 of sub-trench opener 105 may include a fixed portion 105-5 configured for rigid coupling to row unit frame 110 and an adjustable portion 105-4 movably coupled to the fixed portion. This allows the depth of the sub-trench formed at the bottom of planting trench 104 to be adjusted. To provide the adjustability, the adjustable portion 105-4 of bracket 105-3 may include a pair of slots 105-6 which receive threaded fasteners 105-7 which engage the fixed portion 105-5 (see, e.g., FIG. 55).

When notched opener disc 62 and sub-trench opener 105 are combined, notched opener disc 62 can create a general and larger outer furrow in which sub-trench opener 105 can create a smaller sub-trench without sub-trench opener 105 having to perform all of the work, which would lead to more wear on sub-trench opener 105 particularly when encounter crop residue or rocks/stones which may be in the agricultural field.

The seed delivery system 200 includes a seed meter 128, a seed dispensing tube 130, and a first embodiment of a seed inductor such as seed accelerator 300, and that together cooperate to deliver seeds at a preselected rate from seed hoppers 116 or 116′to the soil. Seeds are communicated and transferred from the hopper to seed meter 128 which is configured to singulate the supplied seeds. In one embodiment, seed meter 128 may be a vacuum-type meter such as that disclosed in Applicant's International Patent Publication No. WO/2012/129442 or U.S. Patent Application Publication 2019/0230846, or any commercially available vacuum-type seed meter such as without limitation the VSet® meter, available from Precision Planting LLC, 23333 Townline Rd, Tremont, Ill. 61568. In other embodiments a commercially-available finger-type seed meter may be used.

The seed accelerator 300 (i.e. inductor) is disposed between seed meter 128 and seed dispensing tube 130 for providing air to seed dispensing tube 130 to transport and/or orient seeds for planting. Examples of an inductor which may be used are any of the seed accelerators disclosed herein, any of the inductors listed above for the pressure delivery systems, or those described in U.S. Provisional Application Nos. 63/375,139, filed 9 Sep. 2022, and 63/375,143, filed 9 Sep. 2022.

In operation, the seed meter 128 preferably deposits the supplied seeds into the seed dispensing tube 130 via the seed accelerator 300, which in turn delivers the seed to the planting trench 104. The seed dispensing tube 130 may be removably mounted to a portion or portions of the frame 110.

Seeds dispensed by the seed accelerator 300 from seed meter 128 are directed into and through the seed dispensing tube 130 into the planting trench 104. The seed meter 128 may be configured to receive seeds from the seed hopper 116 or 116′, and orient seeds in a preselected orientation to the seed dispensing tube 130 by any selected method, such as that shown and described in U.S. Patent Application Publication 2019/0230846, “Systems, Implements, and Methods for Seed Orientation with Adjustable Singulators During Planting,” published Aug. 1, 2019. In one embodiment, seed tube 130 can be longitudinally curved as described in U.S. Patent Application Publication 2019/0230846.

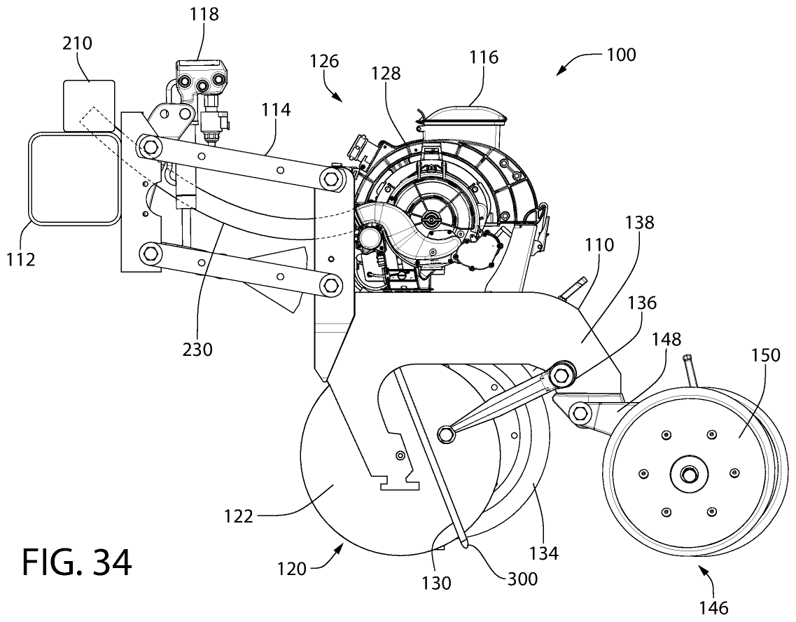

Optionally, a seed orienter 400 shown in FIG. 34 and as described in the publications listed above can be connected to seed tube 130 to orient seeds.

The discharge opening 130-1 at the bottom end of seed dispensing tube 130 is positioned between the opening discs 122 to deliver seed from the seed meter 128 into the opened seed trench 104. The depth of the seed trench 104 is controlled by a pair of gauge wheels 134 positioned adjacent to the opening discs 122. The gauge wheels 134 are rotatably supported by gauge wheel arms 136, which are pivotally secured at one end to the frame 110 about pivot pin 138. An adjustment handle 140 supported by the frame 110 is operably coupled to arms 136 and configured to form a gauge wheel adjustment mechanism. The handle is moveable fore and aft to raise or lower the gauge wheels 134 relative to the frame and opening discs 122. This allows adjustment of and sets the depth of the seed trench 104 by limiting the upward travel of the gauge wheel arms 136 (and thus the gauge wheels 134) relative to the opening discs 122. Accordingly, the depth of cut produced by opening discs 122 is controlled by the gauge wheel adjustment mechanism.

The seed trench closing assembly 146 includes a pair of offset closing wheels 150 which are rotatably and pivotably coupled to frame 110 by closing wheel arm 148. Wheels 150 are angularly disposed relative to each other to “close” the seed trench 104 by pushing the walls of the open seed trench back together over the deposited seed 106 as the row unit 100 passes by. The seed trench closing assembly 146 in some embodiments may be of the type disclosed in U.S. Pat. No. 9,848,524, “Agricultural Seed Trench Closing Systems, Methods, and Apparatus,” granted Dec. 26, 2017.

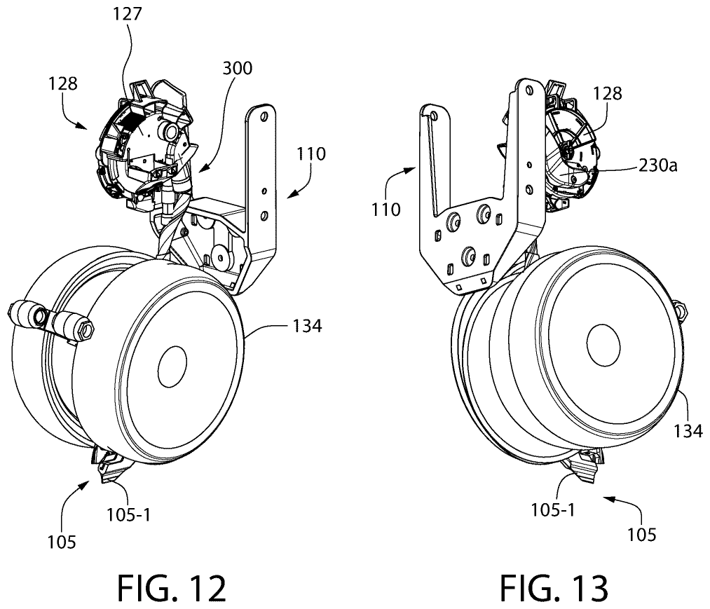

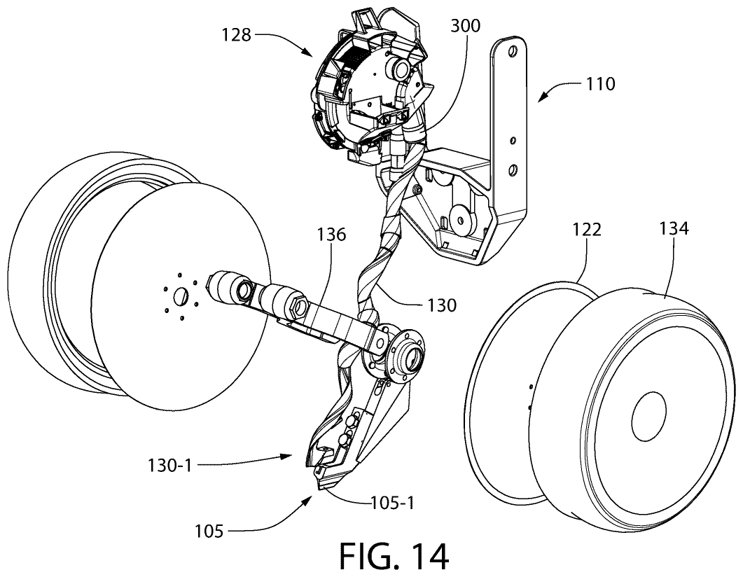

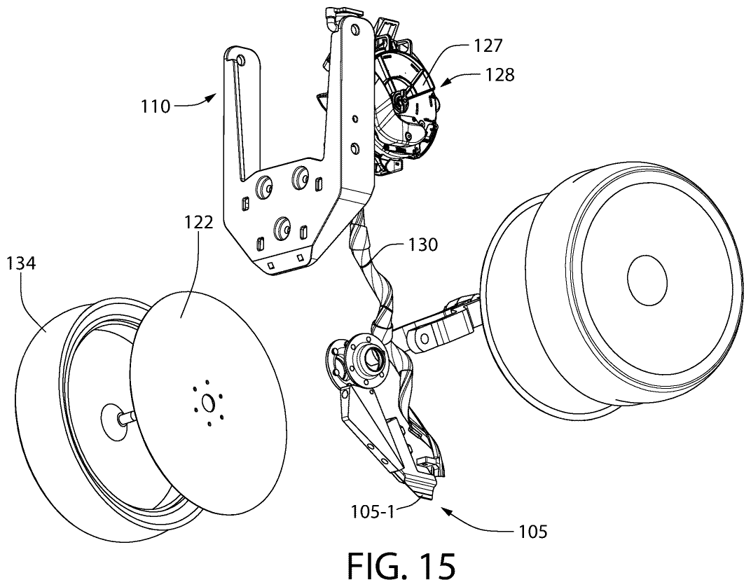

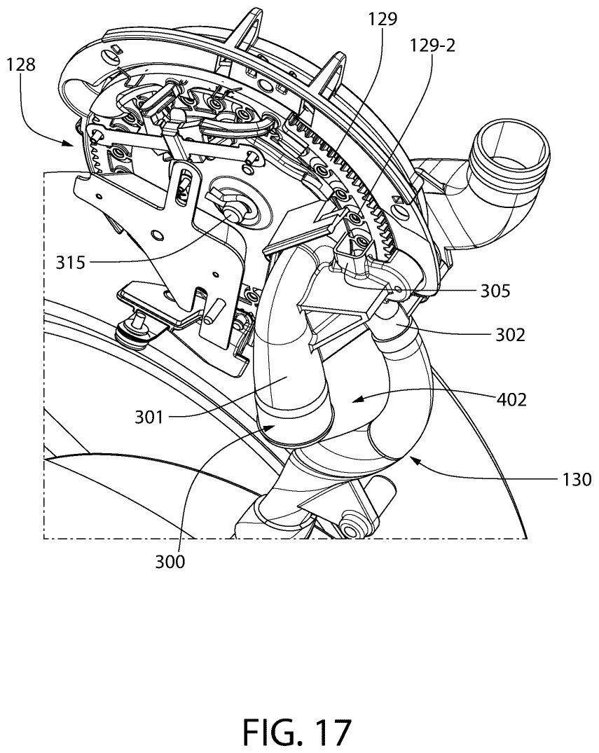

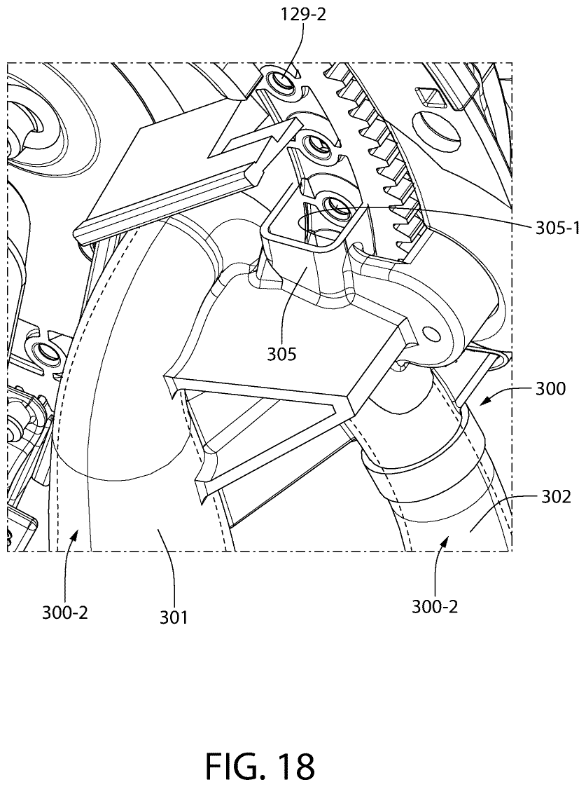

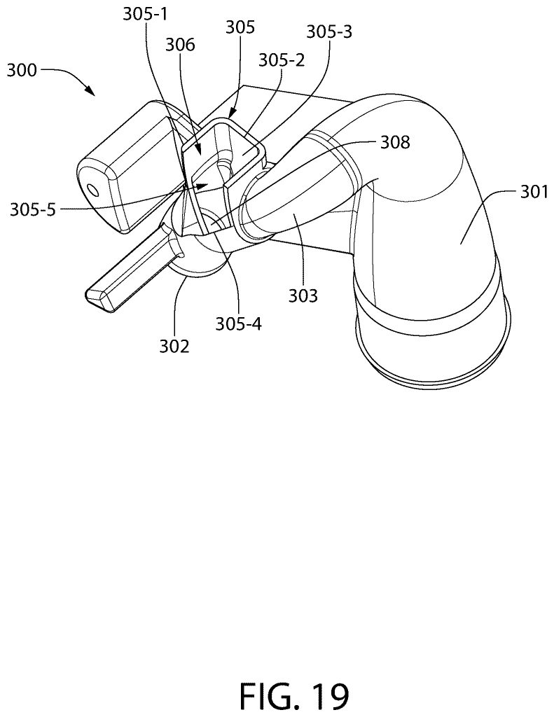

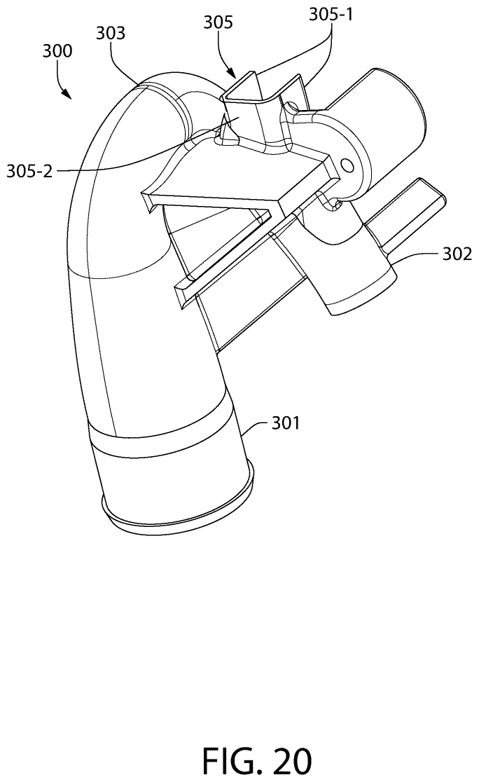

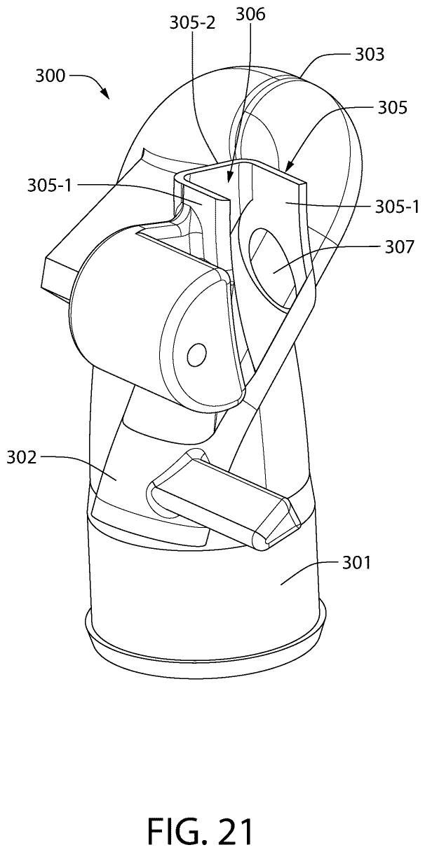

Aspects and components of the seed delivery system 200 will now be further described with general reference to FIGS. 3-16, and in particular to FIGS. 17-23 which show greater details of the seed delivery system components.

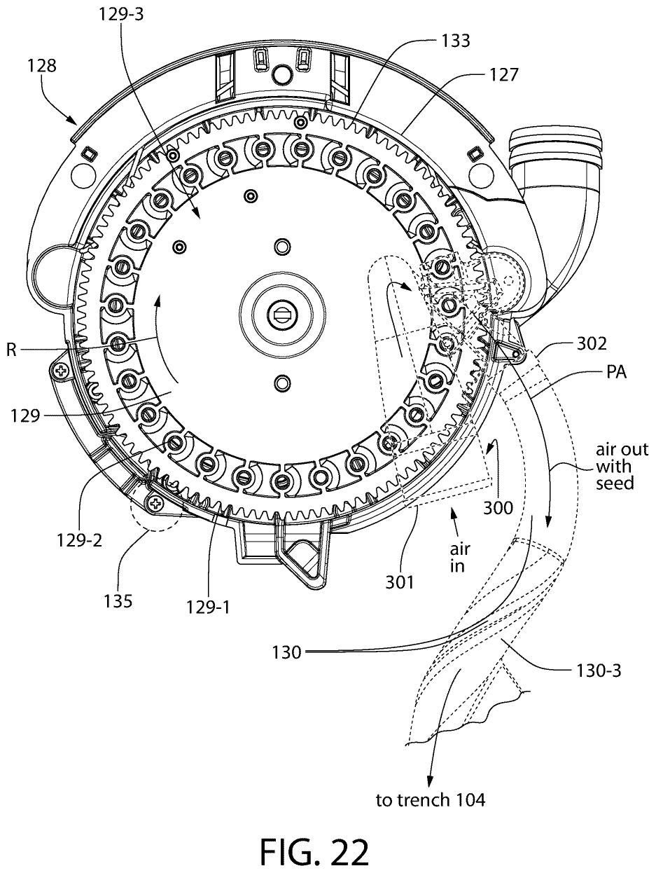

Seed meter 128 comprises a circular outer housing 127 and internal seed metering disc 129 which rotates within the seed meter and receives seed from hopper 116. Disc 129 is rotatably mounted to shaft 315 located at the geometric center of the disc and seed meter 128 which defines a rotational axis RA1 of the disc. Disc 129 rotates in a rotational direction R designated by the rotational arrow shown (e.g., clockwise in FIG. 22). A compatible electric motor drive 135 (represented schematically in FIG. 22) such as a geared motor drive like vDrive commercially-available from Precision Planting LLC, Tremont, Illinois may be used to rotate metering disc 129 at the desired rotational speed. The circumferential peripheral edge 129-1 of the metering disc comprises driven gear teeth 133 which are engaged by mating gear drive teeth of the motor drive to rotate the disc. Other suitable metering disc drive mechanisms may be used.

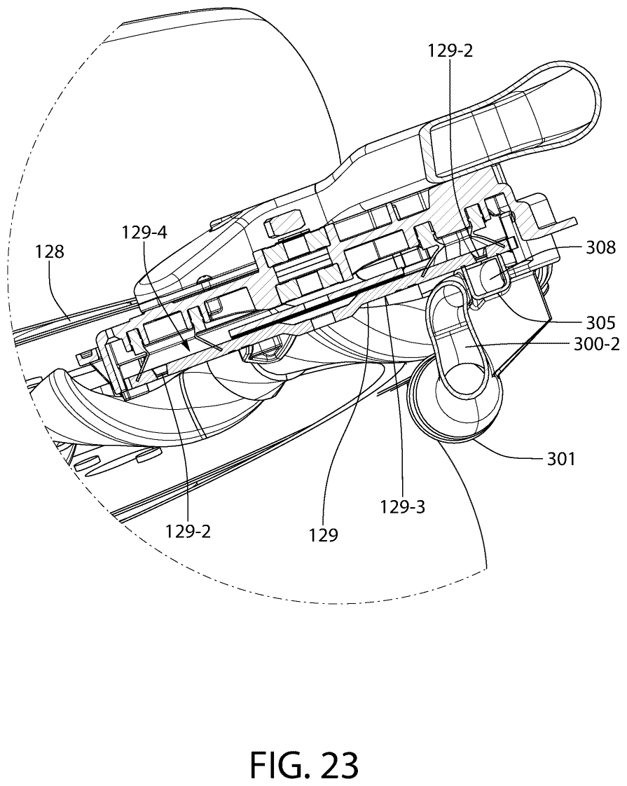

The seed metering disc 129 metering disc includes a circular array of seed holes 129-2 each configured to retain a seed. Seed holes 129-2 are spaced peripherally about a perimeter region of the disc. The seed holes extend completely through metering disc 129 between and through two opposing major surfaces 129-3, 129-4 of the disc (see, e.g., FIG. 23). Holes 129-2 may be radially spaced slightly inward from the circumferential edge 129-1 of disc 129 in one embodiment as shown. Seed holes 129-2 define a circular seed path of travel P of the seeds as the metering disc rotates in rotational direction R. The seed holes 129-2 are circumferentially spaced apart and define pockets in which a single seed is captured from seeds inside seed meter 128 which are drawn from the hoppers 116 or 116′. A vacuum drawn on the seed holes 129-2 from major surface 129-4 of the metering disc 129 (i.e. vacuum side of disc) by a provided commercially-available vacuum system (not shown) used with the vacuum type seed meter like a vDrive® from Precision Planting LLC, Tremont, Illinois attracts and retains a seed in each seed hole on the opposite major surface 129-3 of metering disc 120. The seed metering disc 129 may be oriented vertically when in use and the vacuum may be terminated in one sector of the circular disc (e.g., 3-6 o'clock position) to release the seeds from the seed holes 129-2.

As known in the art, the size and spacing of the seed holes 129-2 may be varied and customized based on the specific type of seed to be planted. As the metering disc 129 rotates, the seed meter 128 singulates and delivers one seed at a time dispensed from hopper 116 or 116′ to seed dispensing tube 130 via seed accelerometer 300, as further described herein. Accordingly, a variety of interchangeable custom metering discs 129 are provided which can be selected for the specific type of seed being planted. The metering discs are removably mountable in seed meter 129 for that purpose.

Either or each of the seed meter 128, seed accelerator 300, and seed dispensing tube 130 may be configured to orient seeds in a preselected orientation to the seed dispensing tube 130 by any selected method. In some embodiments, seed meter 128 may be configured to orient seeds before or as they are delivered to seed dispensing tube 130 via seed accelerator 300. For example, seed meter 128 may include a vision system and a singulator with features (e.g., lobes) configured to orient seeds, such as shown in FIGS. 4A-4C of commonly-owned U.S. Patent Application Publication 2019/0230846, “Systems, Implements, and Methods for Seed Orientation with Adjustable Singulators During Planting,” published Aug. 1, 2019. In some embodiments, a separate seed orientation system is provided either adjacent the inlet to seed dispensing tube 130, intermediate along seed dispensing tube 130, or adjacent the outlet of seed dispensing tube 130. Suitable exemplary seed orientation apparatuses and systems are shown and described in U.S. Patent Application Publications 2020/0367425, entitled “Seed Orientation System for Agricultural Planters” and published Nov. 26, 2020, and 2022/0192079, entitled “Aerodynamic and Centrifugal Seed Orientation System for Agricultural Planters” and published Jun. 23, 2022. In alternative embodiments other types of seed orientation systems are used, including but not solely limited to those described in the background section herein above.

In some embodiments, seed dispensing tube 130 may be generally cylindrical in configuration with a tubular body including a generally cylindrical interior. In other embodiments, the seed dispensing tube 130 may have another shape, for example without limitation a tapered body with gradually reducing moving downwards towards the discharge end of the seed dispensing tube at the bottom (seed exit), or a non-cylindrical geometry.

In the illustrated embodiment, at least a portion of seed dispensing tube 130 may have a helical configuration defining curved and twisting helical seed orientation surfaces 130-3 which engage and manipulate the seeds to provided a predetermined seed orientation for planting in the planting trench (see, e.g., FIGS. 22 and 25-26). FIG. 22 shows a seed dispensing tube 130 combining a plain tubular upper portion coupled to air outlet tube 302 of seed accelerator 300 and a lower helical portion which includes internal helical seed orientation surfaces 130-3. The upper portion of dispensing tube 130 may include a mounting protrusion 130-8 (see, e.g., FIG. 48) configured to couple and support the tube from the row unit frame.

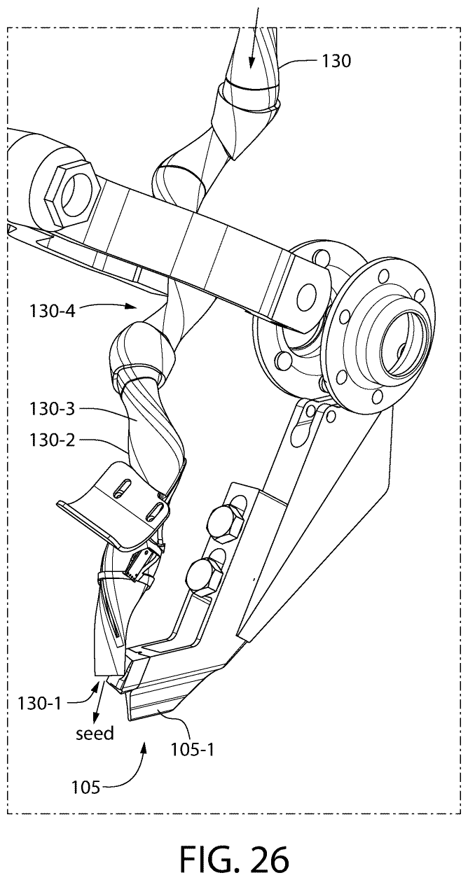

In embodiments including the optional sub-trench opener 105, the bottom end of seed dispensing tube 130 may be detachably coupled to the sub-trench opener for support when the tube travels through the planting trench 104. Referring to FIGS. 26, 49, 51, and 55-56, dispensing tube 130 includes a stabilizing block 520 disposed on the front side of the bottom of dispensing tube 130 near the discharge opening 130-1. In one embodiment, stabilizing block 520 may be detachably coupled to adjustable portion 105-4 of sub-trench opener 105 via a threaded fastener 523 which is inserted through fastener hole 522 in the stabilizing block and mating rearwardly open threaded fastener hole 524 in the adjustable portion (see, e.g., FIG. 56). Other threaded coupling arrangements may be used.

To further stabilize the coupling using only a single fastener 523, stabilizing block 520 may include a forwardly projecting key 521 which is received in rearwardly open keyway 105-2 formed at the rear end of the sub-trench opener mounting bracket 105-3. Key 521 and keyway 105-2 may be vertically elongated and oriented in one embodiment as shown. The key and keyway may be V-shaped in one configuration; however, other suitable complementary configurations may be used. In other embodiments, the key and keyway may be omitted and a pair of threaded fasteners 523 may instead be used to provide stable securement of the seed dispensing tube stabilizing block 520 to the sub-trench opener 105. In addition, other means may be used to fixedly couple the seed dispensing tube 130 to sub-trench opener 105.

In operation, when the stabilizing block 520 is coupled and keyed to the sub-trench opener 105 in the above manner, horizontal and vertical movement of the dispensing tube 130 is inhibited via the rigid coupling therebetween. This protects the bottom end of seed dispensing tube 130 from damage in the event the sub-trench opener blade 105-1 forward of the tube encounters debris in the agricultural field as the row unit forms the planting trench 104.

FIGS. 25-26 show the lower helical portion of seed dispensing tube 130 including a twisted fully enclosed top portion 130-4 and a partially open helical bottom portion 130-2 both of which include the internal helical seed orientation surfaces 130-3. The bottom discharge opening 130-1 is defined at the bottom end of the partially open helical bottom portion 130-2 of the tube 130 as shown enlarged in FIG. 26 and FIG. 50. Discharge opening 130-1 of the seed dispensing tube is downwardly open, and in one embodiment may comprise a vertically-oriented oblong lateral aperture 130-5 which extends upwards for a distance along tube 130 from the open bottom terminal end thereof. In one embodiment, lateral aperture 130-5 may face laterally outwards being formed in the right or left lateral side of seed dispensing tube 130 (best shown in FIG. 50). Advantageously, the lateral aperture 130-5 helps diffuse excess air traveling downwards inside the seed dispensing tube 130 to atmosphere which reduces the velocity of the airstream carrying the seed to promote proper implantation and orientation of the seed in the planting trench. In other possible embodiments, however, the seed dispensing tube 130 may be fully enclosed all the way down to the bottom end that defines the downwardly open discharge opening 130-1 by eliminating the lateral aperture 130-5. Accordingly, numerous variations of seed dispensing tube geometry and configuration are possible to suit the desired application.

In one embodiment, seed dispensing tube 130 may have a one-piece monolithic unitary body structure including the straight and helical portions shown. In the illustrated embodiment, the seed dispensing tube has a segmented body structure comprising a plurality of tube segments 533 coupled together at joints 531 (see, e.g., FIG. 50). Any suitable method may be used to coupled the segments together, such as for example without limitation welding, adhesives, bolted joints, quick-coupling type compression joints, etc. The dispensing tube whether one-piece or segmented structure may be formed of any suitable metallic or non-metallic material. In one non-limiting embodiment, dispensing tube 130 is formed of plastic.

In other embodiments, seed dispensing tube 130 can be configured as a seed orientation tube in which the seed rides/slides along an inside surface of the seed orientation tube and air flowing over the seed orients the seed to the desired orientation for delivery to the planting trench. Examples of seed orientation systems include PCT Publication Nos. WO2018013858A1, WO2018013859A1, WO2018013860A2, and WO2018013861A1. In other embodiments, a seed orientation device such as those described in U.S. Patent Publication No. US2020/0367425A1 and US2022/0192079A1 may be used on conjunction with seed dispensing tube 130 to orient the seeds after discharge from seed meter 128 and the seed dispensing tube before deposition in the planting trench.

Seed meter cover 127 may have a complementary configured curvature approximating the curvature of the seed path of travel P within seed meter 128. Seed meter cover 127 allows seed coming directly off of a desired singulated seed spot within seed meter 128 to enter into seed dispensing tube 130 with air assist via seed accelerator 300, while any other seed or debris that might be in the vicinity of either the desired seed or the seed entrance to seed dispensing tube 130 will be deflected by seed meter cover 207.

### Air Entrainment Seed Accelerator—Inside to Outward Airflow

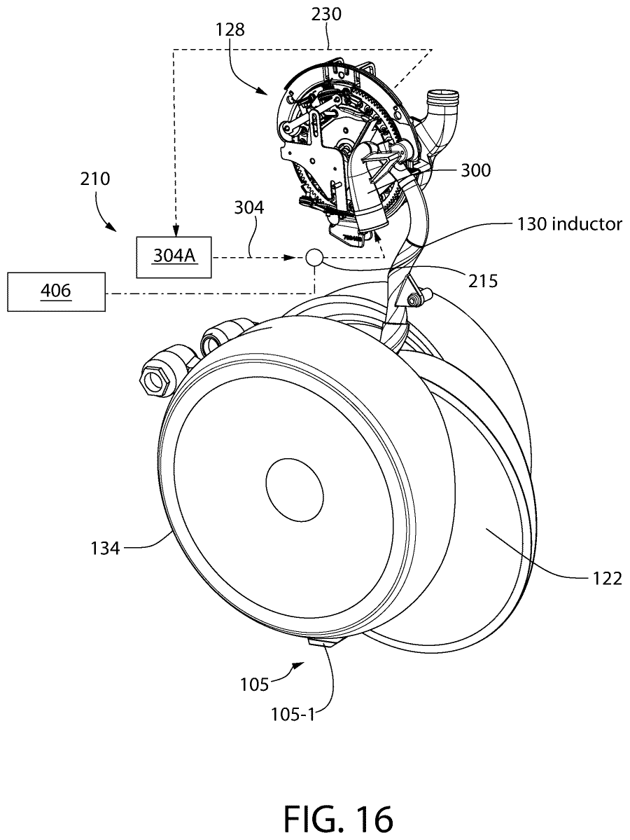

FIGS. 16-23 depict the first non-limiting embodiment of a seed accelerator 300 in greater detail and focus. Seed accelerator 300 comprises a curved and generally tubular body 300-1 configured to operate via air entrainment to strip and capture a singulated seed off metering disc of seed meter 128 and discharge the entrained seed into seed dispensing tube 130 for delivery to the planting trench. The seed accelerator body defines an internal passageway 300-2 thus configured to capture the seed via air induction. Seed accelerator 300 generally comprises an air inlet tube 301, air discharge tube 302, and a recurvant tube bend 303 extending therebetween. Air inlet tube 301 may be funnel shaped in one embodiment as shown having a frustoconical configuration with a larger entrance portion than the discharge portion adjoining tube bend 303. The funnel shape with gradually reducing diameter accelerates incoming pressured air supplied to the air inlet tube from a pressurized air source 304A to positively dislodge and strip a seed from each seed hole 129-2 of seed metering disc 129 as it rotates past the seed accelerator 300 which defines a discharge point on the metering disc. Inlet tube 301 is configured for coupling to an air supply flow conduit 304 such as an air hose or tube coupled to the pressurized air source 304A such as an air compressor or pressurized air tank (shown schematically in FIG. 16). Discharge tube 302 is configured for coupling to seed dispensing tube 130 as shown.

Seed accelerator 300 further comprises a seed capture shroud 305 configured to cover a portion of the seed metering disc 129. Shroud 305 creates a seed capture zone or region through which seeds carried by the metering disc pass as the disc rotates and are entrained in the pressurized airstream flowing through the shroud. The seed capture shroud may be disposed in the tube bend 303 between the air inlet and discharge tubes 301, 302 as shown in one embodiment.

The seed capture shroud 305 have a non-circular shape, and more particularly may have a polygonal shape in certain preferred but non-limiting embodiments. In the non-limiting illustrated embodiment, shroud 305 may be a 3-sided rectilinear structure (e.g., rectangular or square) in one embodiment comprising a pair of opposing end walls 305-1 and a transverse wall 305-2 connected to the opposing walls. Shroud 305 may be generally U-shaped in one embodiment as shown; however, other shapes may be used. Walls 305-1 and 305-2 is an orthogonal arrangement of walls. The walls 305-1 and 305-2 may each be flat as shown in the illustrated embodiment. However, in other embodiments transverse wall 305-2 may be arcuately curved and arched between the end walls. Walls 305-1 are orientated parallel to major surface 129-3 of seed metering disc 129 on one side of the disc. Transverse wall 305-2 is orientated parallel to the major surface 129-3 of metering disc 129. The linear inner edges of walls 305-1 are disposed proximate to major surface 129-3 of the metering disc to minimize air escape between the walls and disc.

Shroud 305 defines an inwardly open air entrainment chamber 306 facing towards seed metering disc 129. Air entrainment chamber 306 defines a portion of the internal passageway 300-2 of seed accelerator 300 through which pressurized air is introduced and flows therethrough. Chamber 306 may have a different cross-sectional shape than the internal passageway 300-2 of the air inlet and outlet tubes 301, 302. Chamber 306 may have a polygonal (e.g., rectilinear or other) cross-sectional shape as shown in the non-limiting illustrated embodiment whereas the air inlet and outlet tubes 301, 302 which form other portions of the passageway 300-2 may have a non-polygonal cross-sectional shape such as circular or oval (albeit which may be of varying diameter in different parts of the tubes).

One end wall 305-1 on the upstream side of shroud 305 includes an air inlet port 307 for introducing pressurized air into cavity 306. The other opposite end wall 305-1 wall includes an air outlet port 308 for air exiting the shroud with the seeds entrained in the airstream which are then conveyed into air discharge tube 302 of seed accelerator 300. Shroud 305 further includes a top opening 305-3 and opposing bottom opening 305-4 each of which communicate with air entrainment chamber 306 of the shroud. These openings define a through passage 305-5 through which the seed holes 129-2 and seeds disposed at least partially therein on metering disc 129 pass as the disc rotates for capture by air flowing through the shroud 305.

Seed accelerator 300 may include one or more mounting brackets 310 configured to detachable fixedly coupling to any suitable available support surface of the row unit, such as for example without limitation a portion of support frame 110 to which seed meter 128 is mounted and/or the meter cover 127. Threaded fasteners may be used in one embodiment for mounting the seed accelerator to the support surfaces. Other mechanical fasteners or clips may be used.

Seed accelerator 300 may have a monolithic body 300-1 in one embodiment in which the mounting brackets 310, air inlet tube 301, recurvant tube bend 303, air discharge tube 302, and shroud 305 are formed as an integral unitary structural part of the body. The seed accelerator body may be formed of a suitable metallic material or non-metallic material (e.g., polymer) fabricated by any suitable method including casting or molding depending on the material used.

The seed accelerator 300 is configured to convey the airstream through the air entrainment chamber 306 of the seed capture shroud 305 from an inward to an outward and downward direction across the metering disc 129 to capture the seeds from the seed holes 129-2.

In operation, the seed holes 129-2 formed in seed metering disc 129 rotate and pass through the seed capture cavity 306 inside seed capture shroud 305 one-by-one as the disc rotates. As previously described herein, each seed is temporarily retained in its respective seed hole 129-2 by a vacuum drawn on the hole from the other major surface 129-4 of the seed metering disc 129 opposite to major surface 129-3 on which the seeds are deposited to pass through the seed accelerator 300.

Pressurized air enters internal passageway 300-2 of seed accelerator 300 via air inlet tube 301 from the outside of the peripheral edge 129-1 of metering disc 129 and flows in a recurvant airflow path PA changing and almost completely (<180 degrees) reversing direction in the passageway to then flow in an airflow path across the metering disc from inside to outside back towards the peripheral edge while crossing the seed path of travel P at the air entrainment chamber 306 inside shroud 305 (see, e.g., FIG. 22). The airflow path PA through internal passageway 350-2 is therefore summarized as from outside to inside of peripheral edge 129-1 of metering disc 129, and changing direction from inside to outside back towards the peripheral edge at a different edge location from where the air was introduced via inlet tube 301. The pressurized airstream is introduced into the air entrainment chamber 306 via air inlet port 307 in shroud 305 and flows across and generally parallel to major surface 129-3 of seed metering disc 129 and across the seed holes 129-2 and seeds therein as they pass in succession one-by-one through the shroud upon rotation of metering disc 129. Air entrainment chamber 306 of shroud 305 is configured to convey the airstream crosswise to a circular seed path of travel P on the metering disc as the metering disc rotates. The crosswise airflow over the seeds disrupts their seating in the seed holes 129-2 to more effectively entrain the seeds in the airstream. The airflow dislodges each seed from its respective seed hole and the seeds becomes inducted into and entrained in the airstream flowing through the shroud. The airstream sweeps and conveys the air-entrained seed through the shroud air outlet port 308 and into the seed dispensing tube 130 coupled to the air discharge tube 302 of the seed accelerator. Seeds may enter shroud 305 at approximately the 3 o'clock position on metering disc 129 where they are entrained in the airstream, and are then swept outwards and discharged from the disc via air outlet tube 302 at approximately the same 3 o'clock position (see, e.g., FIG. 22). The seeds are discharged one-by-one from the bottom end of the seed dispensing tube 130 and deposited in the planting trench. Each seed on seed metering disc 129 is therefore stripped from the disc in succession and deposited in the planting trench as the seeds pass through the shroud 305 in a similar fashion to that described above.

Pressure and flow of air through seed accelerator 300 can be controlled to achieve a preselected seed and air velocity. At slow ground speed of the row unit, low air velocity is desired to prevent disturbing seeds once they are in the furrow. At high ground speeds, high seed velocity is desired to successfully trap seeds in a selected orientation. The seed velocity should be sufficiently greater than ground speed to make lateral motion of the seed relative to the ground negligible as the seed is being lodged into the planting trench.

### Air Entrainment Seed Accelerator—Outside to Inside Airflow

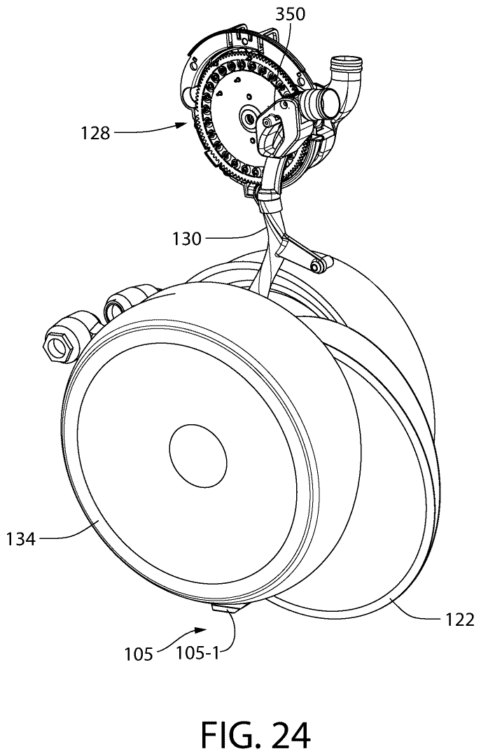

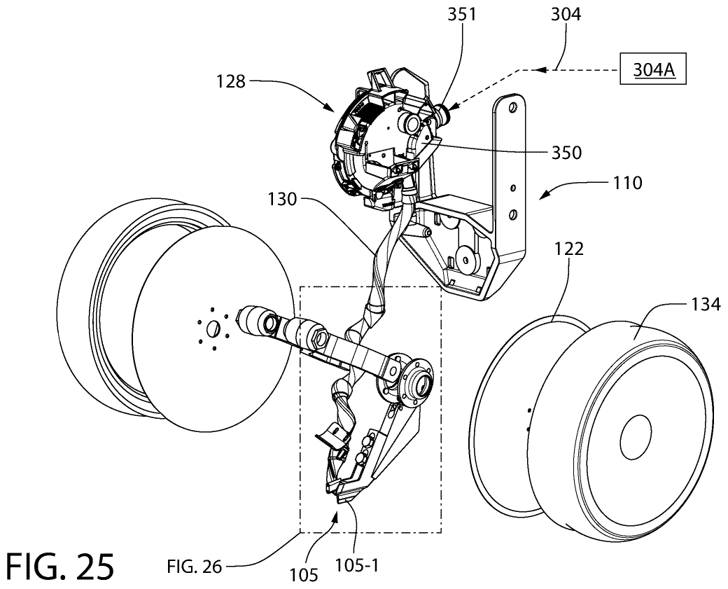

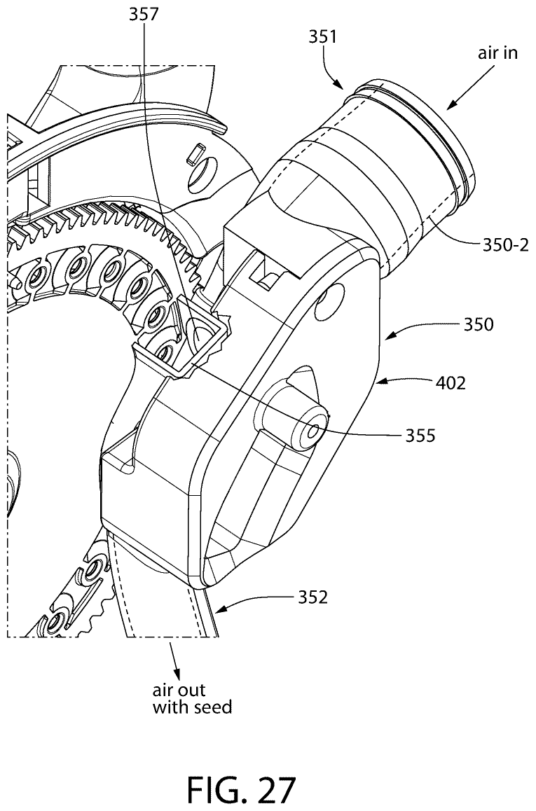

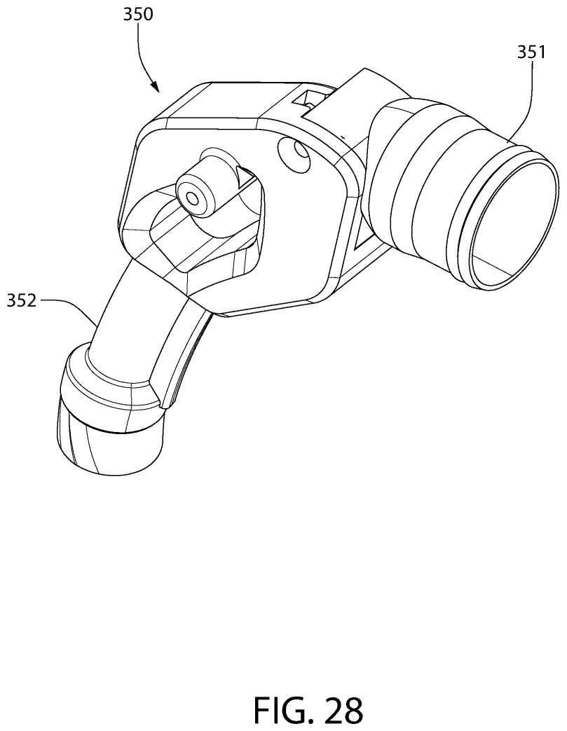

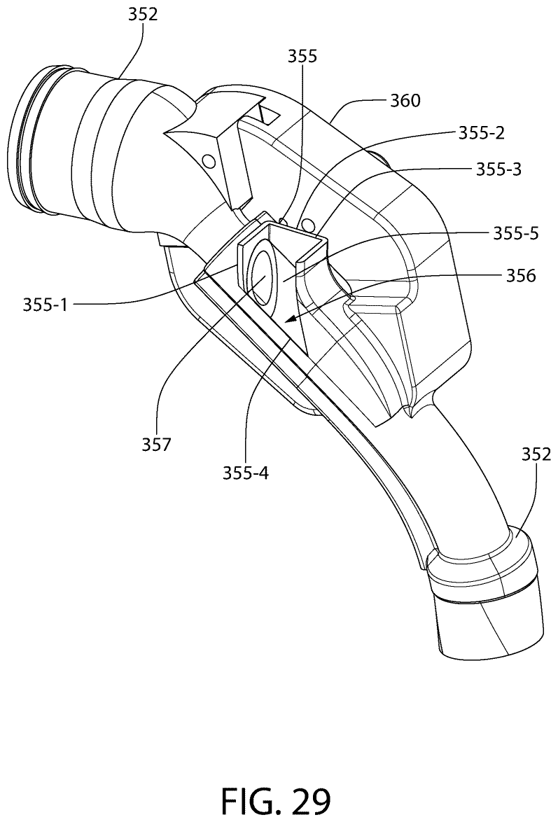

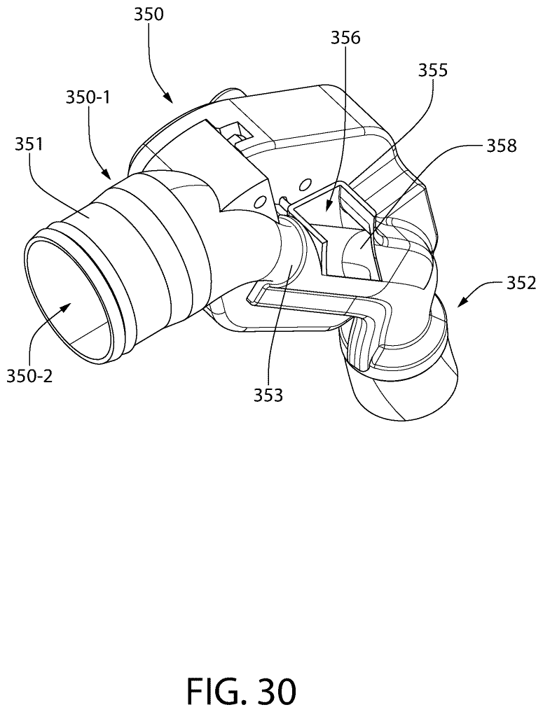

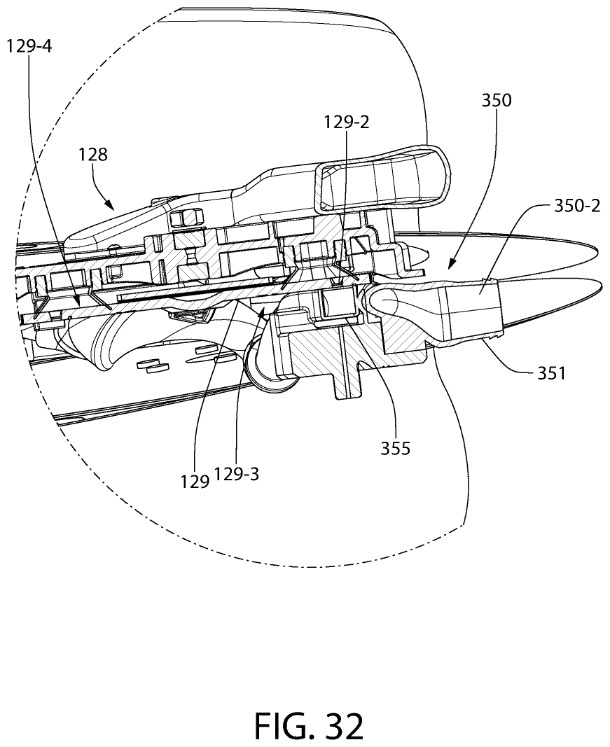

FIGS. 24-32 depict a second non-limiting embodiment of a seed accelerator 350 which comprises a curved and generally tubular body 350-1 configured to operate via air entrainment to strip a singulated seed off metering disc 129 of seed meter 128 and discharge the entrained seed into seed dispensing tube 130 for delivery to the planting trench. The seed accelerator body defines an internal passageway 350-2 thus configured to capture the seed via air induction. Seed accelerator 350 may function generally similar to seed accelerator 300 previously described herein and includes similar parts. However, the present seed accelerator 350 embodiment is configured and arranged to introduce pressured air across major surface 129-3 of seed metering disc 129 in an airflow path from outside the circumferential edge of the disc. The air flows across the disc 129 from edge to edge in a transverse direction instead of in a radially outward direction from inside the disc towards the circumferential edge of disc 129 like seed accelerator 300.

Seed accelerator 350 generally comprises an air inlet tube 351, air discharge tube 352, and an intermediate tube section 353 extending therebetween. Air inlet tube 351 may be funnel shaped in one embodiment as shown having a generally frustoconical configuration with a larger entrance portion than the discharge portion adjoining tube section 353. The funnel shape with gradually reducing diameter accelerates incoming pressured air supplied to the air inlet tube from a pressurized air source to positively dislodge and strip a seed from each seed hole 129-2 of seed metering disc 129 as it rotates past the seed accelerator 300. Inlet tube 301 is configured for coupling to an air supply conduit 304 such as an air hose or tube coupled to the pressurized air source 304A such as an air compressor or pressurized air tank (see, e.g., FIG. 25). Discharge tube 352 is configured for coupling to seed dispensing tube 130 as shown.

Both the air inlet and discharge tubes 351, 352 may be arcuately curved in one configuration as shown in the illustrated embodiment. Other configurations of the tubes may be used to deliver pressurized air in a transverse direction across the surface of the metering disc 129.

Seed accelerator 350 further comprises a seed capture shroud 355 configured to cover a portion of the seed metering disc 129. Shroud 355 functions in a similar manner to shroud 305 of seed accelerator 300 previously described herein. Accordingly, shroud 355 creates a seed capture zone or region through which seeds carried by the metering disc pass as the disc rotates. The capture shroud may be disposed in the intermediate tube section 353 between the air inlet and discharge tubes 351, 352 as shown in one embodiment.

The seed capture shroud 355 may be a 3-sided rectilinear structure (e.g., rectangular or square) in one embodiment similar to shroud 305 previously described herein. Shroud 355 therefore similar comprises a pair of opposing end walls 355-1 and a transverse wall 355-2 connected to the opposing end walls. Walls 355-1 and 355-2 is an orthogonal arrangement of walls. Shroud 355 may be generally U-shaped in one embodiment as shown; however, other shapes may be used. The walls 355-1 and 355-2 may each be flat as shown in the illustrated embodiment. However, in other embodiments transverse wall 355-2 may be arcuately curved and arched between the end walls. Walls 355-1 are orientated parallel to major surface 129-3 of seed metering disc 129 on one side of the disc. Transverse wall 355-2 is orientated parallel to the major surface 129-3 of metering disc 129. The linear inner edges of walls 355-1 are disposed proximate to major surface 129-3 of the metering disc to minimize air escape between the walls and disc.

Shroud 355 defines an inwardly open air entrainment chamber 356 facing towards seed metering disc 129. Chamber 356 may be configured similarly to chamber 306 of seed accelerator 300 previously described herein. Accordingly, the present air entrainment chamber 356 may have a different cross-sectional shape (e.g., rectilinear) than the internal passageway 350-2 of the air inlet and outlet tubes 351, 352 (e.g., circular).

One end wall 355-1 on the upstream side of shroud 355 includes an air inlet port 357 for introducing pressurized air into cavity 356. The other opposite end wall 355-1 wall includes an air outlet port 358 for air exiting the shroud with the seeds entrained in the airstream which are then discharged into air discharge tube 352 of seed accelerator 350. Shroud 355 further includes a top opening 355-3 and opposing bottom opening 355-4 each of which communicate with air entrainment chamber 356 of the shroud. These openings define a through passage 355-5 through which the seed holes 129-2 and seeds disposed at least partially therein on metering disc 129 pass as the disc rotates for capture by air flowing through the shroud 355.

Seed accelerator 350 may include one or more mounting brackets 360 configured to detachable fixedly coupling to any suitable available support surface of the row unit, such as for example without limitation a portion of support frame 110 to which seed meter 128 is mounted and/or the meter cover 127. Threaded fasteners may be used in one embodiment for mounting the seed accelerator to the support surfaces. Other mechanical fasteners or clips may be used.

Seed accelerator 350 may have a monolithic body 300-1 in one embodiment in which the mounting brackets 360, air inlet tube 351, intermediate tube section 353, air discharge tube 352, and shroud 355 are formed as an integral unitary structural part of the body. The seed accelerator body may be formed of a suitable metallic material or non-metallic material (e.g., polymer) fabricated by any suitable method including casting or molding depending on the material used.

In contrast to seed accelerator 300 previously described herein, the present seed accelerator 350 is configured to convey the airstream through the air entrainment chamber 356 of the seed capture shroud 355 from an outward to an inward and downward direction across the metering disc 129 to capture the seeds from the seed holes 129-2.

In operation, the seed holes 129-2 formed in seed metering disc 129 rotate and pass through the seed capture cavity 356 inside seed capture shroud 355 one-by-one as the disc rotates in rotational direction R. Each seed is temporarily retained in its respective seed hole 129-2 by a vacuum drawn on the hole from the other major surface 129-4 of the seed metering disc 129 opposite to major surface 129-3 on which the seeds are deposited to pass through the seed accelerator 350.

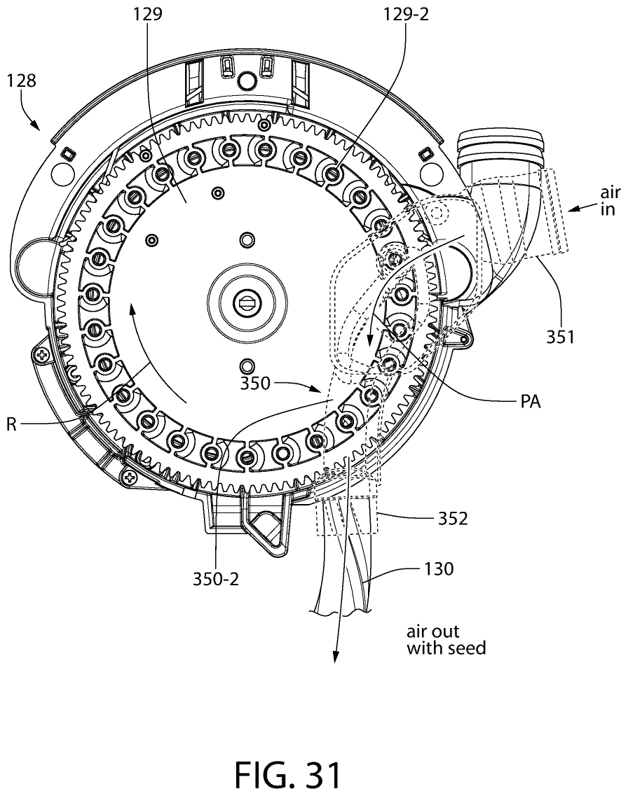

Pressurized air enters internal passageway 350-2 of seed accelerator 350 via air inlet tube 351 from the outside peripheral edge 129-1 of metering disc 129 at a first edge location and flows inwards generally following an arcuately curved airflow path PA to a second edge location while crossing the seed path of travel P at the air entrainment chamber 356 inside shroud 355 see, e.g., FIG. 31 airflow arrows). The airflow path PA through internal passageway 350-2 is therefore summarized as from outside to inside of peripheral edge 129-1 of metering disc 129, across the disc, and then inside to outside the peripheral edge. The pressurized airstream is introduced into the air entrainment chamber 356 via air inlet port 307 in shroud 355 and flows across and generally parallel to major surface 129-3 of seed metering disc 129, and across the seed holes 129-2 and seeds therein as they pass in succession one-by-one through the shroud upon rotation of metering disc 129. Air entrainment chamber 356 of shroud 355 is configured to convey the airstream crosswise to a circular seed path of travel P on the metering disc as the metering disc rotates, similarly to shroud 305 previously described herein. The airflow dislodges each seed from its respective seed hole and the seeds becomes inducted into and entrained in the airstream. In other embodiments, other mechanisms can be used alone or in combination for the seed removal. In one embodiment, a mechanical sweeping or scoop action such as in FR2414288 can be used. In another embodiment, the seed can just fall off the disc at the point that vacuum is terminated. The airstream sweeps and conveys the air-entrained seed through the shroud air outlet port 358 and into the seed dispensing tube 130 coupled to the air discharge tube 352 of the seed accelerator. Seeds may enter shroud 355 at approximately the 3 o'clock position on metering disc 129 where they are entrained in the airstream, and are then swept outwards and discharged from the disc via air outlet tube 352 at a different approximately 5 o'clock position (see, e.g., FIG. 31). The seeds are discharged one-by-one from the bottom end of the seed dispensing tube 130 and deposited in the planting trench.

### Pressure-Vacuum Fan System

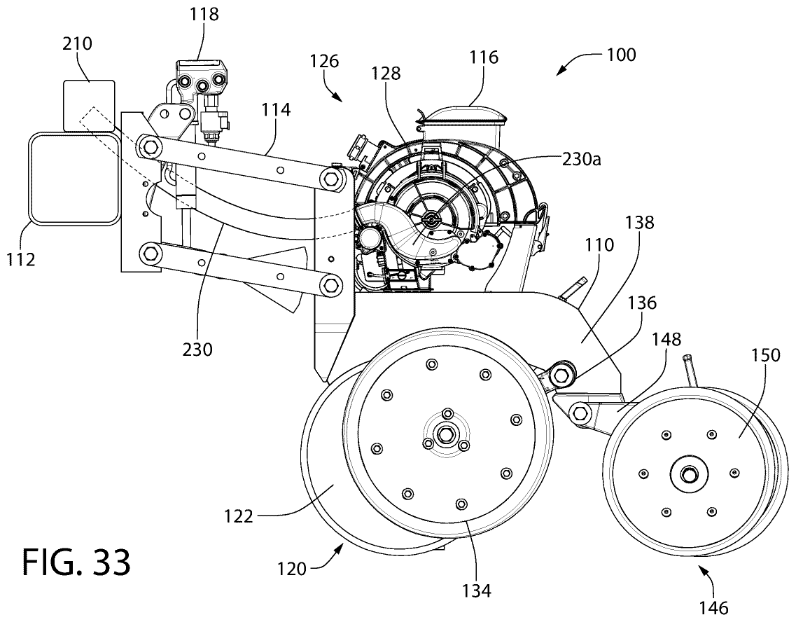

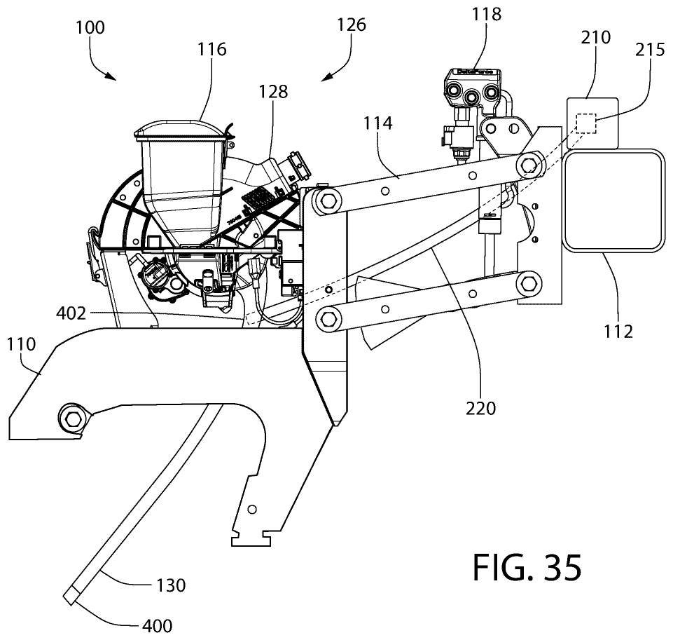

FIGS. 33-35 depict a non-limiting embodiment of a dual-purpose fan system usable for a row unit 100 comprising fan 210. The fan is operable to provide both vacuum for retaining seeds on the seed meter and pressurized air for ejecting seeds from the seed meter for planting.

The suction side of fan 210 is fluidly coupled via flow conduit 230 to seed meter 128 to pull a vacuum on the seed holes 129-2 from major surface 129-4 of the metering disc 129 (i.e. vacuum side of disc) which in turn retains a seed in each seed hole on the opposite major surface 129-3 of metering disc 120. Conduit 230 may be fluidly coupled to seed meter 128 via a suitably configured suction shroud 230a configured to apply uniform pressure to the vacuum side of metering disc 129.

The discharge side of fan 210 is to the seed inductor 402 (e.g., seed accelerators 300 or 350, or another type inductor) via air supply flow conduit 304 to deliver pressurized air to thereto to extract and transport seeds from metering disc 129 into seed dispensing tube 130. Any suitable type of commercially-available flow conduits 230 and 304 may be used such as for example without limitation tubing, hoses, piping, ducting, or other and combinations thereof.

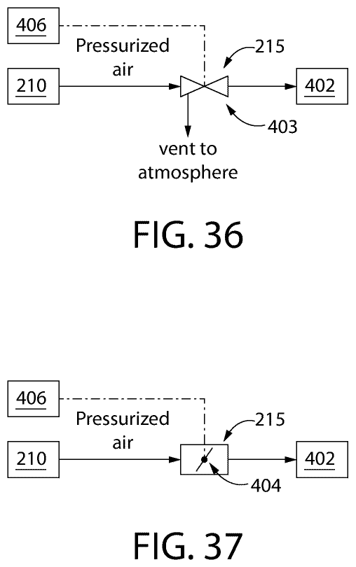

Optionally, a pressure regulator 215 may be included and fluidly interposed between the pressurized discharge side of fan 210 and the inductor 402 to regulate the pressure of air supplied to inductor and in turn seed dispensing tube 130 by the fan. Regulator 215 can be used when there is a mismatch between the amount of air incoming to fan 210 from seed meter 128 on the suction side and the amount needed for seed tube 130 to ensure proper dispensing and orientation of the seeds delivered to the planting trench/furrow by the seed dispensing tube 130. In various embodiments, air pressure regulator 215 may be mounted on the fan, toolbar 112, or row unit support frame 110 at a suitable location. Any suitable commercially-available air pressure regulators may be used. Examples of types of air regulators 215 that may be used include, but are not limited to, a spring-biased pressure reducing valve, a vent, a baffle, or other. Regulator 215 may be a relieving type pressure regulator which vents excess air to atmosphere via a relief valve or port. FIG. 36 is a basic schematic diagram of a relieving type regulator 215 with an air relief vent. FIG. 37 is a basic schematic diagram of a baffle type regulator with an adjustable baffle 404 positioned in the pressurized air flow conduit 304 to adjust air flow and pressure. Moving the baffle from a fully open position with least flow resistance towards a closed position increase resistance thereby decreasing downstream pressure and flow to inductor 402 and in turn seed dispensing tube 130.

Regulator 215 can be controlled and adjusted manually or automatically to obtain and provide a selected amount of air flow and/or a selected amount of air pressure (i.e. set point) to the inductor as needed for proper dispensing velocity and orientation of seeds from seed dispensing tube 130 to the planting trench/furrow. For example, regulator 215 can be adjusted to provide a set point pressure downstream of the regulator to the seed inductor 402 (which in turn controls the air flow rate). Manually adjustable air pressure regulators which are commercially-available sometime provide a rotatable pressure adjustment screw to set the downstream air pressure; however, other manual adjustment means may be provided depending on the type of pressure regulator used.

FIGS. 36 and 37 schematically show a programmable controller 406 for automatically adjusting and controlling the air pressure regulator 215 configured to deliver a user-selectable preprogrammed pressure (e.g., set pressure) and/or flow of air from fan 210 to the inductor 402. Controller 406 is operably and communicably coupled to regulator 215 via suitable wired and/or wireless communication links represented by dash-dot-dash lines such as shown in FIGS. 36-37. The controller automatically adjusts the regulator 215 to maintain the desired preprogrammed air pressure. Too high air pressure delivered to the seed dispensing tube 130 may cause excessive turbulence and velocity which can adversely affect proper orientation and dispensing of seeds to the planting trench 104. Too low air pressure can also adversely affect proper orientation and dispensing of seeds to the planting trench. It is well within the ambit of those skilled in the art to determine the proper air delivery pressure to the seed dispensing tube and corresponding appropriate air pressure for regulator 215 to program into the controller to properly orient and dispense the seeds based on the type plant seeds and their respective weight, shape, and size to be planted.

Controller 406 may be any suitable commercially-available controller with programmable processor and the usual associated electronic components necessary to provide a fully functional and user-configurable controller. Controller 406 may also be operably and communicably coupled to any other components of the row unit 100 described herein and configurable via programming to control operation of those components.

Various arrangements and positioning of fan 210 may be provided to provide a dual vacuum-pressure source to one or more row units which may all be operably mounted to toolbar 112. In some non-limiting embodiments, for example, there can be one dedicated fan 210 for each row unit 100, or there can be one fan 210 supplying vacuum and pressurized air for a plurality of row units 100 in which fan 210 is connected to a plurality of seed meters 128. In the latter arrangement, one air pressure regulator 215 can be provided on the discharge side of the fan which controls the pressure of the air conveyed to the plurality of seed meters, or alternatively each seed meter may have an associated air pressure regulator to allow the air pressure to be individually regulated for each row unit.

### EXAMPLES

The following are nonlimiting examples.

Example 1—An agricultural row unit comprising: a frame; a seed meter disposed on the frame; an inductor coupled to the seed meter; a seed dispensing tube coupled to the inductor; and a fan connected to the seed meter, the fan having a suction side which provides a vacuum to the seed meter and a discharge side which provides pressurized air to the inductor; and a pressure regulator fluidly coupled between the fan and the inductor which adjustably controls a pressure of the air supplied to the inductor.

Example 2—The agricultural row unit according to Example 1, wherein the seed dispensing tube is longitudinally curved.

Example 3—The agricultural row unit according to any preceding Example, further comprising a seed orienter connected to the seed dispensing tube.

Example 4—The agricultural row unit according to Example 1, wherein the pressure regulator is a spring-biased pressure reducing valve.

Example 5—The agricultural row unit according Example 1, wherein the pressure regulator comprises an adjustable baffle to adjust air flow and pressure.

Example 6—The agricultural row unit according to any one of Examples 1-5, wherein the inductor is a seed accelerator comprising an air entrainment chamber configured to extract and entrain the seeds from the seed meter in the air and discharge the air and seeds into the seed dispensing tube.

Example 7—The agricultural row unit according to any one of Examples 1-6, wherein the seed meter comprises a rotating metering disc comprising a circular array of seed holes configured to hold a plurality of seeds in a singulated manner.

Example 8—The agricultural row unit according to Example 7, wherein the fan applies a vacuum to the seed holes on a first major surface of the metering disc which retains the seeds on an opposite second major surface of the metering disc.

Example 9—The agricultural row unit according to Example 8, further comprising a first flow conduit which fluidly couples the suction side of the fan to the first major surface of the metering disc, and a second flow conduit which fluidly couples the discharge side of the fan to the seed accelerator.

Example 10—The agricultural row unit according to any one of Examples 1-9, wherein the frame is pivotably coupled to a toolbar configured to be coupled to a moving vehicle operable to travel across an agricultural field, and wherein the fan is coupled to the toolbar.

Example 11—The agricultural row unit according to Example 10, further comprising a downforce controller operable for transmitting a net downforce between the toolbar and the row unit to keep the row unit positively engaged with the soil.

Example 12—The agricultural row unit according to any one of Examples 1-11, further comprising a programmable controller operably coupled to the pressure regulator, the controller being configurable via programming to maintain a preselected downstream air pressure.

Example 13—The agricultural row unit according to according to any one of Examples 1-12, further comprising an opening assembly supported by the frame and configured to open the planting trench.

Example 14—The agricultural row unit according to Example 13, further comprising a closing assembly trailing the opening assembly, the closing assembly supported by the frame and configured to close the planting trench after implantation of the seeds.

Example 15—An agricultural planter comprising a toolbar and a plurality of row units according to any preceding Example, wherein there is one fan fluidly coupled to a plurality of seed meters of the row units and fluidly coupled to a plurality of the inductors of the row units.

Example 16—The agricultural planter according to Example 15, wherein the fan is mounted on the toolbar.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. An agricultural row unit comprising:
a frame;
a seed meter disposed on the frame;
an inductor coupled to the seed meter;
a seed dispensing tube coupled to the inductor; and
a fan connected to the seed meter, the fan having a suction side which provides a vacuum to the seed meter and a discharge side which provides pressurized air to the inductor; and
a pressure regulator fluidly coupled between the fan and the inductor which adjustably controls a pressure of the air supplied to the inductor.

2. The agricultural row unit according to claim 1, wherein the seed dispensing tube is longitudinally curved.

3. The agricultural row unit according to claim 1, further comprising a seed orienter connected to the seed dispensing tube.

4. The agricultural row unit according to claim 1, wherein the pressure regulator is a spring-biased pressure reducing valve.

5. The agricultural row unit according claim 1, wherein the pressure regulator comprises an adjustable baffle to adjust air flow and pressure.

6. The agricultural row unit according to claim 1, wherein the inductor is a seed accelerator comprising an air entrainment chamber configured to extract and entrain the seeds from the seed meter in the air and discharge the air and seeds into the seed dispensing tube.

7. The agricultural row unit according to claim 1, wherein the seed meter comprises a rotating metering disc comprising a circular array of seed holes configured to hold a plurality of seeds in a singulated manner.

8. The agricultural row unit according to claim 7, wherein the fan applies a vacuum to the seed holes on a first major surface of the metering disc which retains the seeds on an opposite second major surface of the metering disc.

9. The agricultural row unit according to claim 8, further comprising a first flow conduit which fluidly couples the suction side of the fan to the first major surface of the metering disc, and a second flow conduit which fluidly couples the discharge side of the fan to the seed accelerator.

10. The agricultural row unit according to claim 1, wherein the frame is pivotably coupled to a toolbar configured to be coupled to a moving vehicle operable to travel across an agricultural field, and wherein the fan is coupled to the toolbar.

11. The agricultural row unit according to claim 10, further comprising a downforce controller operable for transmitting a net downforce between the toolbar and the row unit to keep the row unit positively engaged with the soil.

12. The agricultural row unit according to claim 1, further comprising a programmable controller operably coupled to the pressure regulator, the controller being configurable via programming to maintain a preselected downstream air pressure.

13. The agricultural row unit according to according to claim 1, further comprising an opening assembly supported by the frame and configured to open the planting trench.

14. The agricultural row unit according to claim 13, further comprising a closing assembly trailing the opening assembly, the closing assembly supported by the frame and configured to close the planting trench after implantation of the seeds.

15. An agricultural planter comprising a toolbar and a plurality of row units according to any preceding claim, wherein there is one fan fluidly coupled to a plurality of seed meters of the row units and fluidly coupled to a plurality of the inductors of the row units.

16. The agricultural planter according to claim 15, wherein the fan is mounted on the toolbar.
